(19) United States
(12) Patent Application Publication
(10) Pub. No.: US 2009/0311390 A1
(43) Pub. Date: Dec. 17, 2009

(54) PET FOOD TREATS, PET FOOD TREATS PROCESSING SYSTEM, AND PROCESS FOR MAKING THE PET FOOD TREATS

(76) Inventors: John Phelps, Andover, NJ (US); Mary Kathryn Winstanley, Hoboken, NJ (US); Robert P. Teitelbaum, Haddonfield, NJ (US); Scott Morris, Chatham, NJ (US); Thomas Ray, Claremont, CA (US)

Correspondence Address: DLA PIPER LLP US, P. O. BOX 2758, RESTON, VA, 20195, US

(21) Appl. No.: 12/482,486

(22) Filed: Jun. 11, 2009

Related U.S. Application Data
(60) Provisional application No. 61/060,918, filed on Jun. 12, 2008.

(51) Int. Cl. A23K 1/10; B65B 25/06; G07F 9/10

(52) U.S. Cl. 426/129; 426/392; 426/302; 426/410; 426/250; 426/316; 426/324; 99/356

(57) ABSTRACT

A process for making pet food treats including a meat base, the treats themselves and a processing system for making the treats. The meat base is ground to obtain a ground meat base. The ground meat base is mixed with one or more ingredients to obtain a meat mixture. Slugs of the meat mixture are formed. The slugs of meat mixture are cooked to obtain cooked slugs of meat mixture. The cooked slugs of meat mixture are chilled. The cooked slugs of meat mixture are packaged while reducing the amount of oxygen in the package.

### CROSS-REFERENCE TO RELATED APPLICATIONS

This application is based on and derives the benefit of U.S. Provisional Patent Application No. 61/060,918, filed on Jun. 12, 2008, the contents of which are incorporated herein by reference in its entirety.

### FIELD OF THE INVENTION

The present invention relates to food in general and more particularly to pet food treats, process for making the pet food treats, and pet food treats processing system.

### BRIEF DESCRIPTION OF THE DRAWINGS

FIG. 1 is a schematic diagram of a food processing system for making pet food treats, according to an embodiment of the present invention;

FIGS. 2A and 2B show a front view of a meat pieces forming device and a side view of the meat pieces forming device, respectively, according to an embodiment of the present invention;

FIG. 2C is a schematic representation of a meat pieces forming device in a sequence for forming slugs, according to an alternate embodiment of the present invention;

FIG. 2D is a schematic representation of a meat pieces forming device, according to yet another embodiment of the present invention;

FIG. 3 is a broken away view of a cooking device, according to an embodiment of the present invention; and

FIG. 4 is a schematic representation of a cooler in a spiral configuration.

### DETAILED DESCRIPTION OF EMBODIMENTS OF THE INVENTION

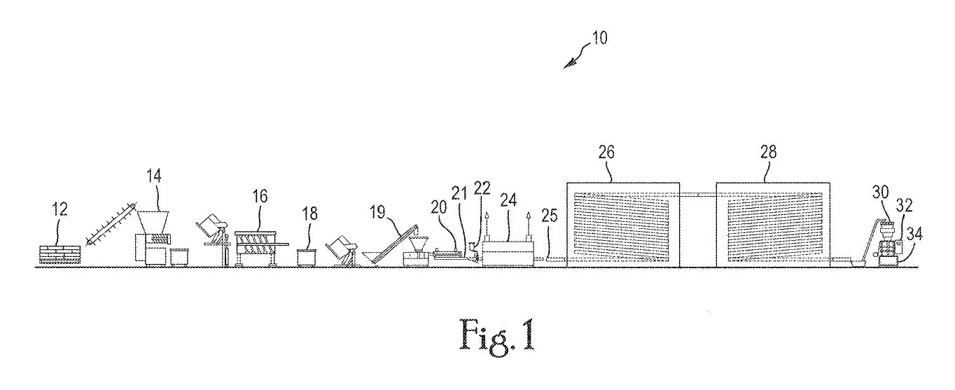

FIG. 1 is a schematic diagram of a food processing system for making pet food treats, according to an embodiment of the present invention. The food processing system 10 comprises a tempering device 12, a grinding device 14, a mixing device 16, a temperature equilibrating device 18, meat pieces forming device 20, a spray coating device 22, a browning device (such as a broiler or searing oven) 24, a cooking device 26, a chilling device 28, a weighting device 30, a metal detection device 32, and a packaging device 34.

Meat can be received at sub-zero temperatures, although fresh meat can also be employed. A meat base can be prepared for grinding by adjusting the temperature of the meat base in tempering device 12 to a temperature between about 15° F. and about 28° F., for example about 26° F. to form blocks of meat base. If initially at sub-zero temperatures, the meat can be held in the tempering device 12 for about 4 days to about 12 days to achieve the desired temperature. The meat base may include beef, pork, lamb, goat, horse, buffalo, venison, elk, moose, chicken, turkey, duck, fish, or any other seafood, or any combination of two or more thereof. The meat base frozen blocks are ground using grinding device 14 to reduce the frozen blocks of meat base to a desired size, from about 3/32 inch (2.38 mm) to about ⅜ inch (9.52 mm) chunks, for example about ⅛ inch (3.17 mm) chunks, for mixing and forming. The ground frozen meat blocks are then transferred to mixing or blending device 16. In the mixing/blending device 16, the meat base is combined with other ingredients and can optionally be subjected to vacuum to form a homogeneous meat mixture. The vacuum can remove entrapped air and can provide a more dense and homogenous blend. The vacuum can be applied at a level from about 0 to about 30 inches Hg, for example, about 26 inches Hg.

The meat mixture is prepared by mixing the meat base with a binding agent, a moisturizing compound, a salt, a humectant such as a sugar, an acid or corresponding salt thereof, a mold inhibitor, an encapsulated acid, a flavoring and aroma compound, a coloring compound, or a condiment, or any combination of two or more thereof. The meat base can be used in an amount between about 3% and about 80% by weight of the meat mixture, for example about 70% by weight of the meat mixture. The binding agent can be used in an amount between about 5% and about 20% by weight of the meat mixture, for example about 18% by weight of the meat mixture. The type and amount of binding agent can be selected so that the resulting product is not sticky and no residual is left on the pet owners' finger-tips. For example, the binding agent can be added to “buffer” or to absorb fat content in the meat mixture. The binding agent can also facilitate the blending of the various ingredients and provide a “wetter or more flowable” meat mixture. The moisturizing compound can be used in an amount between about 3% and about 25% by weight of the meat mixture, for example about 7% by weight of the meat mixture. Salt can be used in an amount between about 0% and about 15% by weight of the meat mixture, for example about 3% by weight of the meat mixture. Salt adds flavor and aids in myofibrillar protein extraction, a step that can be associated with meat particle binding in forming a formed meat piece. The humectant including sugar can be used in an amount between about 0% and about 10% by weight of the meat mixture, for example about 2% by weight of the meat mixture. The humectant (e.g., sugar) can be used to reduce water activity to below about 0.98, for example between about 0.92 and about 0.98. Water activity is a measure of the availability of water in a food for microbial growth such as molds, and is designated a_{w}. A measurement of a_{w} on a food provides information as to which types of microorganisms are most likely to cause spoilage and how close the a_{w} is to the safety limits. The acid or corresponding salt thereof can be used in an amount between about 0% and about 5% by weight of the meat mixture, for example less than about 1% by weight of the meat mixture. The mold inhibitor can be used in an amount between about 0% and about 7% by weight of the meat mixture, for example about 0% by weight of the meat mixture. The encapsulated acid can be used in an amount between about 0% and about 5% by weight of the meat mixture, for example less than about 1% by weight of the meat mixture. The flavoring and aroma compound can be used in an amount between about 0% and about 5% by weight of the meat mixture, for example less than about 1% by weight of the meat mixture. The coloring compound can be used in an amount between about 0% and about 4% by weight of the meat mixture, for example less than about 1% by weight of the meat mixture. The condiment can be added in an amount between about 0% and about 20% by weight of the meat mixture. In various embodiments, each of these ingredients other than the meat base is optional, such as the ingredients with a percentage range starting at 0%.

The binding agent can include, but is not limited to, oat flour, soy flour, wheat flour, rice flour, potato flour, corn flour, rye flour, buckwheat flour, chestnut flour, chickpea flour, atta flour, pea flour, bean flour, amaranth flour, arrowroot flour, taro flour, cattail flour, acorn flour, sorghum flour, or tapioca flour, or a combination of two or more thereof. The moisturizing compound can include, but is not limited to, water, broth from mammal, poultry or fish, juice including mammal, poultry or fish, or any combination of two or more thereof. The humectant, for example sugar can include, but is not limited to fructose, dextrose, maltodextrin, honey, high-fructose corn syrup, maltose, brown sugar, coconut sugar, date sugar, sucanat, molasses, turbinado sugar, dextrin, glucose, sucrose, sucralose, or any derivative thereof, or any combination of two or more thereof.

The acid can include, but is not limited to, citric acid, ascorbic acid, phosphoric acid, lactic acid, folic acid, acetic acid, adipic acid, benzoic acid, fumaric acid, maleic acid, propionic acid, sorbic acid, succinic acid, tartaric acid, or phytic acid, or any derivative thereof, or any combination of two or more thereof, or any of the salts thereof. The acid can be used as a flavouring agent, preservative agent, and/or for pH adjustments. The acid can be used to lower the overall pH of the meat mixture, e.g., a pH below about 5.8, for example a pH between 4.5 and 5.7, so as to inhibit or reduce the growth of bacteria in the meat mixture. In addition, a selected amount of acid can be used to produce a desired flavor in the meat mixture. Each acid can have its own flavor profile including sourness intensity and lasting time and non-sourness including sweetness, bitterness and astringency. For example, in the case of a lactic acid (e.g., L(+)-lactic acid), the lactate ion of lactic acid can be a contributor to taste in meat. Lactic acid has a mild lingering taste while citric acid has a sharp astringent taste. For example, adding lactate in any form (e.g., sodium lactate, potassium lactate, calcium lactate, etc.) to meat products can have a flavor enhancing impact. For example, the addition of lactates to a meat product containing meat extract results in an enhanced meat taste. In general, lactates contribute to a meaty taste. Lactates can be added to a meat product to enhance flavor without decreasing the pH of the meat product. Lactates can also improve microbial quality and control pathogens in meat products and hence can extend the shelf life of the meat product. They may also play a role in enhancing color and texture as well as have anti-oxidant properties. The acid can be added in an encapsulated form or regular form. In the encapsulated form, the acid can be used to enhance texture. The mold inhibitor can include, but is not limited to, potassium sorbate, cultured whey, calcium propionate, cultured dextrose, cultured yeast, benzoic acid, acetic acid, or plum powder, or any derivative thereof or any combination of two or more thereof. The encapsulated acid can include, but is not limited to, encapsulated lactic acid, encapsulated citric acid, or encapsulated glucono-delta-lactone (GDL), or any derivative thereof, or any combination of two or more thereof. The encapsulated acid can be used as a flavor enhancer, as a time released color enhancer, or both. The internal (inclusion) or external (coating) flavoring and aroma compound, which can provide cosmetic or palatability enhancement, can include, but is not limited to, garlic (e.g., garlic concentrate, garlic oil, garlic powder, garlic aroma), onion (e.g., onion concentrate, onion oil, onion powder, onion aroma), natural smoke flavor, hickory, mesquite, anchovy, chicken, lobster, tikka, tandoori, parsley, spinach, saffron, digestive (liquid stomach contents of an animal, e.g., chicken), phosphate, yeast, or enzymatic liver (pork, turkey or chicken), or any derivative thereof, or any combination of two or more thereof. The internal (inclusion) or external (coating) coloring compound can include, but is not limited to, caramel coloring, malliouse, allura red AC, annatto, astaxanthin, betanin or beetroot red, blue 2, brilliant black BN, brilliant blue FCF, brown FK, canthaxanthin, carmine, carotene, crocin, curcumin, erythrosine, FD&C orange number 1, iron oxide, orange B, ponceau 6R, red 40, red 2G, saffron, sunset yellow FCF, tartrazine, titanium dioxide, turmeric, yellow 5, or yellow 2, or any combination of two or more thereof. The internal (inclusion) or external (coating) condiment, which can provide cosmetic or palatability enhancement, can include, but is not limited to, parsley flakes, carrots, spinach, tomatoes, potatoes, peas, rice, or pasta, or any combination of two or more thereof.

In one embodiment of the invention, chicken meat is used as a meat base for the meat mixture. Chicken meat can include, for example, necks, breasts, or backs, or any combination of two or more thereof, with or without cartilage and/or bone ground to small grid sizes (i.e., emulsified). Chicken meat can also include necks, breasts, or backs, or any combination of two or more thereof, that are deboned using a deboner and ground to desired plate sizes (i.e., emulsified). Chicken meat can include mechanically separated chicken (MSC). Chicken meat can also include a mixture of deboned or bone-in chicken, mixed together in various portions. The chicken meat is used in an amount of about 70% by weight of the meat mixture. The flour, in this case oat flour, is incorporated in amount of about 17% by weight of the meat mixture. Water is added in an amount of about 7% by weight of the meat mixture, salt is added in an amount of about 3% by weight of the meat mixture. Sugar, in this case dextrose, is added in an amount of about 2% by weight of the meat mixture. The acid, in this example citric acid, is used in an amount of less than about 1% by weight of the meat mixture. Potassium sorbate or vinegar can be used in an amount of less than about 1% by weight of the meat mixture. Encapsulated citric acid is used in an amount of less than about 1% by weight of the meat mixture. Concentrated garlic is used in an amount of less than about 1% by weight of the meat mixture.

In another embodiment of the invention, a mixture of beef meat and chicken meat is used as a meat base for the meat mixture. In this example, a mixture of beef hearts and mechanically separated chicken (MSC) is used as a meat base. The beef meat is used in an amount of about 35% by weight of the meat mixture. The MSC meat is used in an amount of about 35% by weight of the meat mixture. The flour, in this case oat flour, is incorporated in amount of about 17% by weight of the meat mixture. Water is added in an amount of about 7% by weight of the meat mixture, salt is added in an amount of about 3% by weight of the meat mixture. Sugar, in this case dextrose, is added in an amount of about 2% by weight of the meat mixture. The acid, in this example citric acid, is used in an amount of less than about 1% by weight of the meat mixture. Vinegar or potassium sorbate can be used in an amount of less than about 1% by weight of the meat mixture. Encapsulated citric acid is used in an amount of less than about 1% by weight of the meat mixture. Concentrated garlic is used in an amount of less than about 1% by weight of the meat mixture. Caramel is used in an amount of less than about 1% by weight of the meat mixture.

In one embodiment, the binding agent which can include a flour such as oat flour is added last to allow all other ingredients to blend well. All other ingredients are first added to the meat and are mixed to provide a “wetter” meat mixture and then the flour is added to the obtained wet meat mixture.

After mixing the meat base with other ingredients and optionally subjecting it to a vacuum in the mixing device 16 to obtain a meat mixture, if desired, the temperature of the mixture can be checked. If the temperature is higher than about 26° F. to about 28° F., the mixture can be cooled, for example, by adding CO₂. Then, the meat mixture can be transferred to temperature equilibration device 18. In the equilibration device 18, the temperature and moisture content of the blended ingredients in the meat mixture can be equilibrated. The blended meat mixture can be stored in a refrigerated room having an environmental temperature between about 28° F. and about 38° F. for a period of about 8 hours to about 48 hours, for example, about 12 hours to about 24 hours. The resulting temperature of the meat mixture inside the refrigerated room can be between about 15° F. and about 28° F., for example about 26° F.

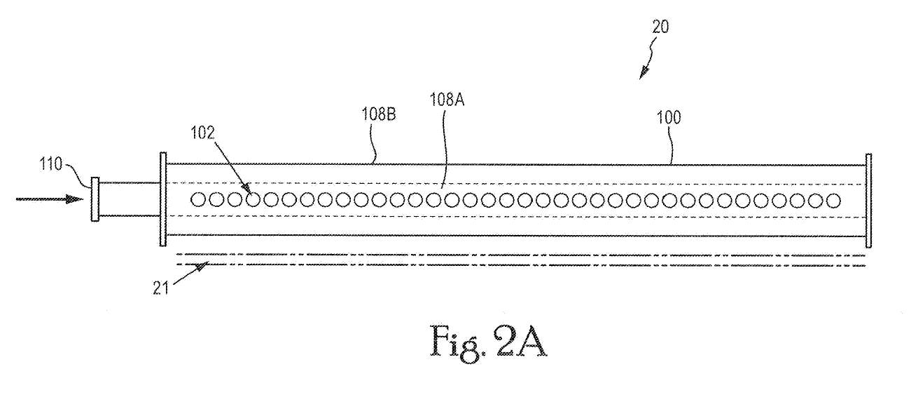

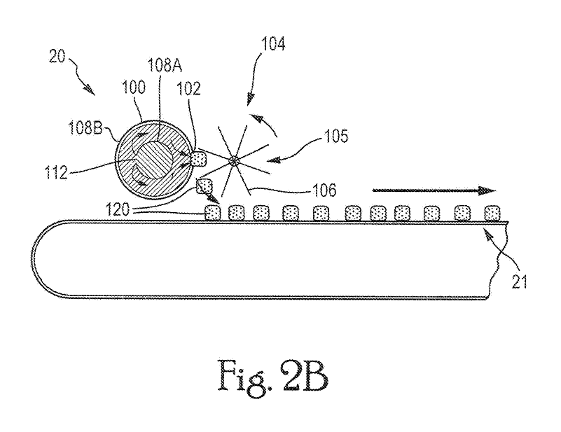

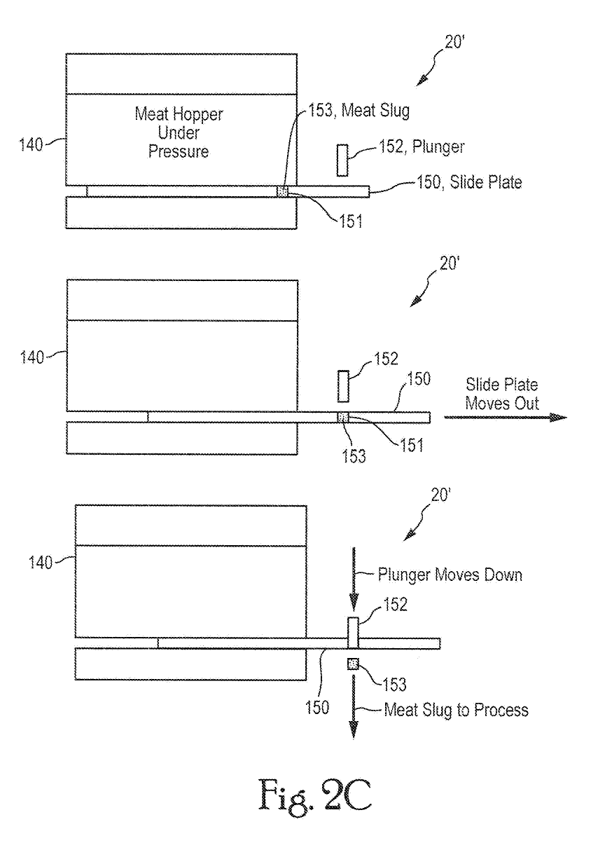

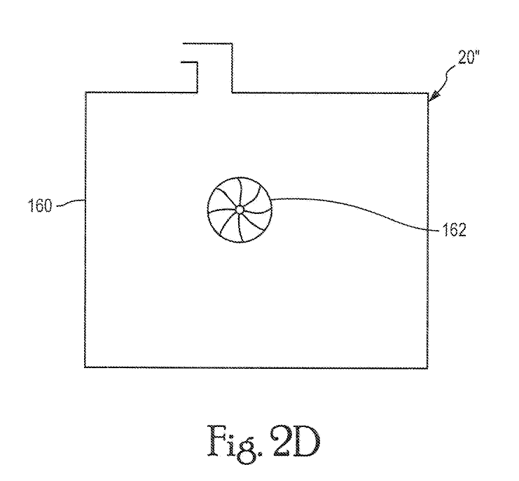

The meat mixture can be transported to meat pieces forming device 20 through transport mechanism 19. FIG. 2A shows a front view of the meat pieces forming device 20 and FIG. 2B shows a side view of the meat pieces forming device 20, according to an embodiment of the present invention. As shown in FIGS. 2A and 2B, the meat pieces forming device 20 has a container 100 having a plurality of holes 102 (e.g., about 30 holes) and a circular cutting device 104 having one or more wheels 105 disposed adjacent to a surface of the container 100. The one or more wheels 105 has a plurality of blades 106 having edges disposed adjacent to holes 102. In this embodiment, the container 100 has a cylindrical shape on which holes 102 are disposed in a linear fashion along a surface of the cylindrical container 100. In one embodiment, the container 100 comprises an inner feed tube 108A and an outer extrusion tube 108B on which the holes 102 are provided. The meat mixture is introduced through inlet 110 into the inner feed tube 108A. In one embodiment, the meat mixture is pumped through the inlet 11 using a VEMAG™ vacuum stuffing pump commercialized by Reiser Corporation. The inner tube 108A has an opening 112 facing opposite to the holes 102. This equilibrates a pressure inside the container so that a pressure at each hole 102 is approximately the same. The meat mixture is forced through the holes 102 and streams of meat mixture are output through the holes 102 continuously. When the one or more wheels 105 of the cutting device 104 is rotated, each blade 106 cuts through the stream of meat mixture intermittently to form slugs 120 of meat mixture. The slugs 120 then drop onto a conveyor 21 which transports the slugs 120 of meat mixture to the coating device 22. The conveyor 21 can be sprayed with a liquid, or passed through a bath of liquid, such as water, so that the meat pieces do not stick to the conveyor 21. In another embodiment, instead of using the blades 106 in the one or more wheels 105 to cut through the stream of the meat mixture, a cutting disk, a cutting plate, or a guillotine-like device, or the like can be used to cut through the stream of meat mixture intermittently to form the slugs of meat mixture.

FIG. 2C is a schematic representation of meat pieces forming device 20′ in a sequence for forming slugs, according to an alternate embodiment of the present invention. In this embodiment, the meat pieces forming device 20′ is a “plug former.” The meat pieces forming device 20′ comprises a meat hopper 140, a slide plate 150 and a plunger 152. The slug plate 150 has holes 151. Initially, the slide plate 150 is inside the meat hopper 140. The meat hopper 140 is under pressure so that the meat mixture inside the meat hopper 140 penetrates into the holes 151 of the slug plate 150 so as to fill the holes 151 to form the meat slugs 153, as depicted at the beginning of the sequence at the top of FIG. 2C. The slide plate 150 is then moved, i.e., slid, out of the meat hopper 140 and the plunger 152 is moved down so as to expulse the meat slugs 153 from the holes 151, as shown at the end of the sequence at the bottom of FIG. 2C.

FIG. 2D shows a schematic representation of meat pieces forming device 20″ in a sequence for forming slugs, according to yet another embodiment of the present invention. In this embodiment, the meat pieces forming device 20″ is an “iris machine.” The meat pieces forming device 20″ comprises a meat hopper 160 and an iris or sphincter 162. The meat mixture is under pressure inside the meat hopper 160. The iris or sphincter 162 opens and closes similar to the iris of photographic camera. The meat mixture is forced through the iris 162. By opening and closing the iris 162 meat slugs can be formed. The size and shape of the meat slugs can be varied by varying the speed of opening or closing of the iris 162.

In one embodiment, the slugs of meat mixture are cylindrical in shape. The speed of the stream(s) of meat mixture and the rotation speed of the blades 106 in wheels 105 of the cutting device 104 in meat pieces forming device 20 can be selected so as to change the size of the slugs of meat mixture. The speed of the stream of meat mixture can be changed by changing the pressure of meat mixture inside the container 100 of the forming device 20. In one embodiment, the speed of the stream of meat mixture and the rotation speed of the cutting device is selected so as to form cylindrically shaped slugs of meat mixture having a base diameter of about 0.5 inch (12.7 mm) and a length of about 1.5 inch (38.1 mm). However, the speed of the stream of meat mixture and the rotation speed of the cutting device can also be selected or adjusted so as to change the length of the slug of meat mixture. Similarly, the pressure inside the meat hopper 160 in meat pieces forming device 20″ and/or the speed of opening and closing of the iris 162 in meat pieces forming device 20″ can be varied to change the size and/or shape of the meat pieces. In meat pieces forming device 20′, the size and/or shape of the meat pieces can be changed by selecting a slug plate 150 having holes 151 with desired dimensions or shape so as to form the meat pieces 153 with desired dimensions and/or shape.

In one embodiment, the slug of meat mixture has a base diameter smaller than the length of slug, although any slug size can be employed. Furthermore, although the slugs are generally made cylindrical in shape, the slugs can be made with other shapes and conformations. For example, the geometrical shape of the base of the cylinder can be selected as desired, such as made round or polygonal. In addition, the slugs can be shaped so as to form, generally round-shaped meat pieces (generally referred to as meatballs), cubic-shaped meat pieces, cylindrical-shaped meat pieces (for example, meat pieces resembling sausages), polygonal-shaped meat pieces, pyramid-shaped meat pieces, heart-shaped meat pieces, flat-wafer-shaped, or other more complex-shaped meat pieces. Furthermore, by running two meat pieces forming devices in parallel where each meat pieces forming device is arranged to form a different shape, color and/or texture of meat pieces, two or more streams of different shapes, colors and/or textures of meat pieces can be mixed together to create a variety of meat pieces that enhances the overall visual appeal. For instance, parallelepiped-shaped meat pieces that are dark brown or golden can be mixed with cylindrical-shaped meat pieces that are less dark so that there are distinct portions blended in a desired proportion to create an appetite appeal.

After exiting the meat forming device 20, 20′ or 20″, the meat pieces can be transported using conveyor 21 to a browning device 24. Before entering into the browning device 24, the meat pieces (e.g., sausage-shaped meat pieces) are sprayed by the liquid spraying device 22. The liquid spraying device 22 sprays the meat pieces to coat the meat pieces with the coloring compound. The meat pieces are coated on the bottom, or on the top, or both. In one embodiment, the coloring compound comprises water and caramel. Water and caramel are mixed together in specific proportions before spraying on the meat pieces (e.g., meatballs). Water can be used as a diluting agent to decrease viscosity. In one embodiment, water can be used in an amount between about 0% to about 97% by weight of the total liquid mixture. Caramel can be used in an amount between about 0.5% to about 7% in weight of the total liquid mixture. Vinegar can also be used in an amount between about 0% to about 100% by weight of the total liquid mixture. Prior to browning, a flavoring and aroma compound and/or a condiment can be applied.

In the browning device 24, the color of the meat pieces is changed to improve the overall appearance of the meat pieces. Browning is a technique used in grilling, roasting, braising, sautéing, etc. to cook the surface of a food, such as meat poultry or fish, at a relatively high temperature so that a caramelized crust forms. In one embodiment, the browning device is an open flame oven that sears the surface of the meat pieces so as to form brown/golden colored meat pieces. The meat pieces are exposed to flames inside the oven. A temperature inside the oven can be set to a value between about 250° F. and about 500° F., for example about 400° F. The time period of the meat pieces reside inside the browning device 24 is between about 20 seconds to about 60 seconds, for example about 45 seconds. However, the time period can be increased or decreased depending upon the temperature in the browning device or depending upon the desired final appearance of the meat pieces when the meat pieces exit the browning device 24.

Alternatively, the browning device 24 may not be used and can be eliminated. In which case, the color changing of the meat pieces can take place in the atmosphere, for example by reaction with the oxygen in the atmosphere. Alternatively or in addition to using the browning device 24, a fryer can be used to fry the meat pieces to obtain fry-coated meat pieces. Alternatively or in addition, the meat pieces can also be branded with a heat generating device if desired. Alternatively, the color changing process can be eliminated entirely.

In one embodiment, the meat pieces are browned/golden-colored to improve the overall appearance of the meat pieces and also to potentially enhance water retention as the meat pieces are color coated with a crusty brown/golden outer layer. The brown/golden outer layer is a result of the reaction of proteins, fat and the liquid mixture containing vinegar, caramel and water with heat through caramelization and a Maillard reaction. In addition to improving the overall appearance, the taste of the meat pieces is also enhanced. In a Maillard reaction, the reactive carbonyl group of sugar (e.g., sugar in caramel) interacts with the nucleophilic amino group of the amino acid, and an interesting odor and flavor molecules result from the reaction. In the reaction process, hundreds of different flavor compounds can be created. These compounds in turn break down to form yet more new flavor compounds, and so on. Each type of food has a very distinctive set of flavor compounds that are formed during the Maillard reaction.

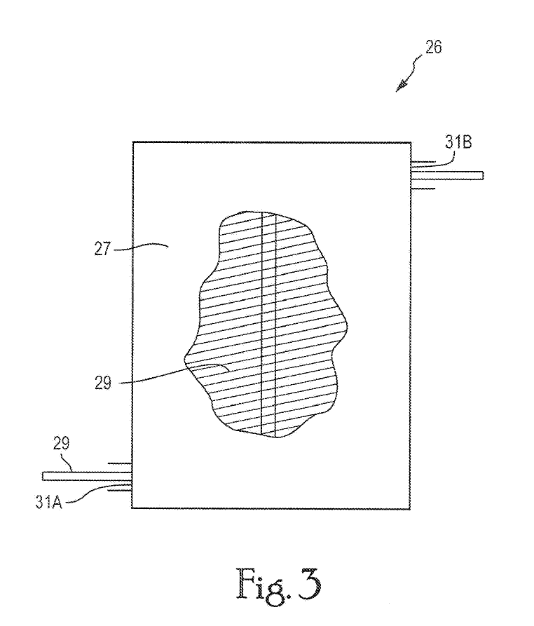

The meat pieces can then be transferred via conveyor 25 to cooking device 26. Prior to cooking, a flavoring and aroma compound, a coloring compound and/or a condiment can optionally be applied to the meat pieces. FIG. 3 shows a broken away view of the cooking device 26 showing an internal portion of the cooking device 26, according to an embodiment of the present invention. In this embodiment, the cooking device 26 can be a gas fired oven having a cooking chamber 27. Moisture can be introduced into the cooking chamber 31 in a form of steam to maintain a humidity of about 0% to about 60%, for example about 20%. The cooking device 26 also includes one or more conveyors 29 arranged inside the cooking chamber 27. The conveyor or conveyors 29 may be formed from a wire mesh. In one embodiment, as shown in FIG. 3, the conveyor 29 is arranged in a spiral conformation.

In one embodiment, the meat pieces enter the cooking device 26 through an inlet 31A provided at the bottom of the cooking device 26 and exit through an outlet 31B provided at the top of the cooking device 26. The meat pieces are guided by conveyor 29 inside the cooking chamber 27 in a spiral configuration from the bottom of the cooking device 26 to the top of the cooking device 26. A hot steam of water vapor can be introduced to create a humidified atmosphere inside the oven 27. The above cooking device is described having a conveyor in a spiral configuration. However, the cooking device can also have a conveyor of any suitable configuration, a cooking device without a conveyor or any other type of cooking device.

The meat pieces are cooked inside the cooking chamber to allow proper pasteurization and kill bacteria and fungal growth. The meat pieces are cooked in the cooking device 26 at an environmental temperature between about 250° F. and about 500° F., for example about 300° F. In one embodiment, the meat pieces are cooked to a temperature (a core temperature) of approximately 160° F. during a period of about 3 minutes to about 20 minutes, for example about 9 minutes. However, the cooking time period can be increased or decreased depending on the desired cooking temperature.

In the above embodiment, the cooking device 26 is described as being an open flame oven. However, the cooking device 26 can be any type of cooking device such as, but not limited to, an electric oven, a steam cooker, a microwave oven, a microwave-convection oven, or a combination of two or more thereof.

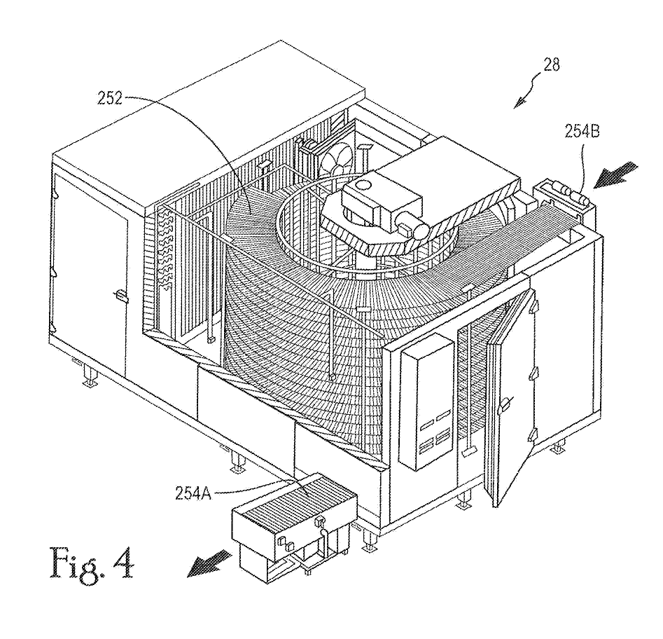

The cooked meat pieces can then be transferred into the cooling device or chilling device 28 for cooling the meat pieces. Prior to or after chilling, a flavor and aroma compound, a coloring compound and/or a condiment can optionally be applied to the cooked meat pieces. In one embodiment, the cooling device 28 is a spiral chiller. FIG. 4 is a schematic configuration of a typical spiral chiller. As shown in FIG. 4, the cooling device 28 comprises a conveyor 252 arranged in a spiral configuration. In one embodiment, the meat pieces enter the cooler through inlet 254A provided at the top of the cooler 28 and exit through outlet 254B provided at the bottom of the chilling device 28. The conveyor 252 guides the meat pieces in a spiral configuration from the top of the cooling device 28 to the bottom of the cooling device 28. Alternatively, the meat pieces enter the cooler through an inlet provided at the bottom of the cooling device 28 and exit through an outlet provided at the top of the cooling device 28. In which case, the conveyor 252 guides the meat pieces in a spiral configuration from the bottom of the cooling device 28 to the top of the cooling device 28. Cold air or any other cold gas is forced through the conveyor (e.g., a wire mesh conveyor) which transports the meat pieces to cool the meat pieces. Air or gas that is warmed by contact with the meat pieces is re-circulated and passed through refrigerated plates to cool the air/gas and then the air/gas is blown again over the meat pieces. This process can be repeated numerous times until the meat pieces are cooled to a desired temperature. The above cooling device 28 is described having a conveyor in a spiral configuration. However, the cooling device 28 can also have a conveyor of any suitable configuration, a cooling device without a conveyor or any other type of cooling device. The internal temperature inside the cooling device 28 is maintained between about −50° F. to about −10° F., for example −40° F. As a result, the meat pieces are cooled from a core temperature of about 160° F. to a core temperature of about 40° F. in a period of about 2 minutes to about 20 minutes, for example, about 15 minutes. A frozen crust can form on the meat pieces. The surface temperature of the meat pieces can be about between 18° F. and about 36° F. but can be at 26° F.

After the meat pieces are cooled, the meat pieces can then be transferred to measuring device 30 so as to weigh and divide the meat pieces into portions of approximately equal size. For example the meat pieces can be divided into portions weighting about 8 oz which can contain approximately 10 to 100 meat pieces, for example, about 30 to about 35 pieces, depending on the size of the meat pieces. The portions of meat pieces can then be transferred into packaging device 34. Packaging machine 34 can load the portions into gas flushed plastic resealable bags. The bags can be pre-made or made on-line from roll stock. If made from roll stock, the bag can vertical form filled and sealed or horizontal form filled and sealed. In one embodiment, the packaging device 34 is a vertical flexible packaging machine. The vertical packaging machine provides a vertical form fill sealed bag which is filled with the meat pieces. In one embodiment, a VIKING™ machine commercialized by Leonhard Packaging Solution, Inc. is used. Another embodiment uses a vertical formed filled machine PAC machine (PAC Machinery). Horizontal machines can also be used. The bag is sealed on one end on four corners so as to provide a stand up filled bag. On the other end of the bag, a resealable mouth is provided. In one embodiment, the bag is made of a sheet of flexible plastic such as polyethylene (PE), polypropylene (PP), polyethylene terephthalate (PET) or the like. The sheet of flexible plastic can be translucent or semi-opaque or opaque. In addition, the sheet can be provided with a certain color or texture by addition of an additive during the manufacturing of the sheet of plastic. Furthermore, a label or an image can be imprinted directly on the plastic sheet or imprinted on another material such as paper and then adhered onto the plastic sheet. The imprint can be made before forming the plastic bag or after forming the plastic bag.

In the packaging device 34, the bags are filled with the portions of meat pieces. In one embodiment, air in the bags is displaced (either drawn via a vacuum or pushed with an inert gas or gas blend) so as to reduce the level of oxygen in the bags. Then the bags are filled with the meat pieces and the bags are purged in an atmosphere filled with nitrogen or an inert gas such as argon, or a combination of these gases. The residual oxygen in the atmosphere filled with nitrogen or inert gas is about 7% or less, for example, about 1.5% or less. In another embodiment, the bags are filled with the portions of meat pieces in a modified atmosphere containing nitrogen, inert gas (e.g., argon), carbon dioxide, or carbon monoxide, or any combination of two or more these gases. Any of these gasses can comprise about 0% to about 100% by weight of the gas composition. In one embodiment, the bags of meat pieces are filled with meat pieces in an atmosphere comprising about 30% to about 70% by weight of nitrogen gas, about 30% to about 70% by weight of carbon dioxide, and about 0% to about 8% by weight of carbon monoxide. The purpose of the evacuation/gas flush is to reduce the amount of oxygen in the bag.

Prior to or after filling the bags, the meat pieces can be sent through metal detection device 32. If the presence of metal is detected in the meat pieces, the contaminated bag can be removed from the production line.

Thus, the resulting pet treat can be a natural pet treat that requires refrigeration. By natural, this application refers to a feed or ingredient derived solely from plant, animal or mined sources, either in its unprocessed state or having been subject to physical processing, heat processing, rendering, purification, extraction, hydrolysis, enzymolysis or fermentation, but not having been produced by or subject to a chemically synthetic process and not containing any additives or processing aids that are chemically synthetic except in amounts as might occur unavoidably in good manufacturing processes as defined in the Association of American Feed Control Officials (AAFCO) guide. That is no chemical preservatives need be added.

The resulting pet treat can be made such that it does not leave sticky or oily residue on the fingers of the pet owner or consumer who handles the pet treat. In general, meat when cooked has some degree of meat juice and fat. On one hand, handling cooked meat with meat juice or fat may not be desirable by the pet owner or consumer. On the other hand, the fat content in the meat is a driver of palatability. Therefore, reducing the fat content or using lean meats may not be desirable for reducing sticky residue on the fingers of consumer who handles the pet treat. Therefore, a challenge is to have a pet treat that “handles hygienically” (i.e., leaves a minimum amount of residue on the fingers of the consumer) but at the same time, be made of meat for increased palatability and good ingredients. The fact that the treat is refrigerated makes the challenge even more difficult because chilled meat tends to feel clammy to touch and fat and residue can become stickier.

The above described process for making pet treats can produce pet treats that leave minimum or substantially no sticky residue on the fingers of the pet owner or consumer who handles the pet treats. For example, the addition of flour (e.g., oat flour) can help soak up the fat content in the meat mixture, hence substantially reducing the potential of having a sticky residue when handling the pet treats. In addition, special blending techniques (e.g., vacuum blending as described in the above paragraphs) and other processes or techniques, such as using warm to hot water to maximize blending and reduce the occurrence of frozen chunks, can further enhance the soaking of the meat juices and fat. These techniques can also prevent the fat from the meat to surface to the exterior of the meat. Furthermore, the use of a dry oven with reduced humidity, as described in the above paragraphs, can produce pet treats having a surface coated with a micro-skin that can substantially block any expulsion of fat or meat juice that could otherwise coat the surface or appear as a result of synerisis.

In addition to the above aspects, the above process for making pet treats can also produce pet treats with a shelf life between about 14 weeks and about 22 weeks, when refrigerated, by significantly impeding bacterial and fungal growth from spoilage levels without reducing palatability or using preservation techniques that can lead to stool problems for the pets. While a refrigerated shelf life of the resulting pet treats is between about 14 weeks and about 22 weeks is desirable.

Various parameters can play a role in determining the shelf life of the pet treats while ensuring balanced spoilage and at the same time maintaining palatability, texture, color, and appearance without affecting stool quality while meeting regulatory standards as set by the Association of American Feed Control Officials (AAFCO). For example, one parameter may be selecting an appropriate humectant, for example a sugar such as dextrose and/or maltodextrin, and selecting the appropriate proportions for the humectant so that the water activity a_{w} is between about 0.92 and about 0.98. Another parameter may be the selection of an appropriate salt/water phase. Indeed, natural meat has a moisture level of between about 68% and about 75%. A reduction of the moisture content in the meat mixture can improve the shelf life of the pet treats. For example in one embodiment, the moisture level is selected to be between about 50% and about 60% with a salt content between about 2% and about 3%. Yet another parameter is selecting the fat content in the meat mixture. For example in one embodiment, the fat content is between about 7% and about 11%. Another parameter is controlling the atmosphere inside the pouch which contain the pet treats. For example in one embodiment, a modified atmosphere with a residual oxygen of less than about 2% is established. Another parameter is controlling the pH of the meat mixture by inclusion of an acid such as lactic acid and/or citric acid. For example in one embodiment, the pH is set between about 4.8 to about 5.8, including total titratable acid. Another parameter is controlling the cooking temperature and the cooking time of the meat mixture pieces. For example in one embodiment, the cooking device is set to about 300° F., i.e., the environmental temperature inside the cooking chamber is set to about 300° F., and the meat pieces are cooked for approximately 8 minutes to 12 minutes at a humidity between about 15% and about 45% to achieve a core temperature in the meat pieces between about 165° F. and about 190° F. Another parameter is to control the cooling of the cooked meat pieces. For example in one embodiment, the cooked meat pieces are chilled from a core temperature between about 165° F. and about 190° F. down to a temperature between about 18° F. and about 36° F., for example, 26° F., within 20 minutes.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments. Accordingly, all suitable modifications and equivalents should be considered as falling within the spirit and scope of the invention.

In addition, it should be understood that the figures, are presented for example purposes only. The processes, food compositions and packaging of the present invention are sufficiently flexible and configurable, such that it may be utilized in ways other than that shown in the accompanying figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed:

1. A process for making pet food treats including a meat base, comprising:
grinding the meat base to obtain a ground meat base;
mixing the ground meat base with one or more ingredients to obtain a meat mixture;
forming slugs of the meat mixture;
cooking the slugs of meat mixture to obtain cooked slugs of meat mixture;
chilling the cooked slugs of meat mixture; and
packaging the cooked slugs of meat mixture while reducing the amount of oxygen in the package.

2. The process of claim 1, further comprising cooling the meat mixture prior to forming the slugs of meat mixture.

3. The process of claim 1, wherein the one or more ingredients include a binding agent, a moisturizing compound, a salt, a sugar, an acid or a corresponding salt thereof, a mold inhibitor, an encapsulated acid, a flavoring and aroma compound, a coloring compound, or a condiment, or any combination of two or more thereof.

4. The process of claim 1, further comprising decreasing a temperature of the meat base to form chilled blocks of meat base, the grinding including grinding the chilled blocks of meat base.

5. The process of claim 1, further comprising:
coating the slugs of meat mixture with a liquid; and
browning the coated slugs of meat mixture.

6. The process of claim 1, wherein the coating of the slugs of meat mixture comprises coating the slugs with a mixture of water and caramel.

7. The process of claim 1, wherein the cooking of the slugs of meat mixture comprises cooking the slugs of meat mixture using an open flame cooking oven cooking device.

8. The process of claim 5, wherein the browning of the slugs of meat mixture comprises searing the slugs of meat mixture in an open flame oven.

9. The process of claim 1, wherein the cooking of the slugs of meat mixture comprises cooking the slugs of meat mixture in a gas fired oven with a steam to maintain a humidity of about 20% inside the oven.

10. The process of claim 1, wherein the packaging comprises filling plastic bags with the slugs of meat mixture.

11. The process of claim 10, wherein the filling of the bags with the slugs of meat mixture comprises filling the bags with the slugs of meat mixture in an atmosphere filled with a gas comprising nitrogen, inert gas, carbon dioxide, or carbon monoxide, or any combination of two or more thereof.

12. The process of claim 1,
wherein the mixing of the ground meat base with one or more ingredients comprises:
adding dextrose, maltodextrin, or both as such that a water activity is between approximately 0.92 and approximately 0.98,
adding a salt in an amount between approximately 2% and approximately 3% to obtain a meat mixture with a moisture level between approximately 50% and approximately 60%, and
adding lactic acid, citric acid or both such that the pH in the meat mixture is between approximately 4.8 and approximately 5.8, including total titratable acid,
wherein the meat mixture has a fat content between approximately 7% and approximately 11%;
wherein the cooking of the slugs of meat mixture comprises cooking the slugs of meat mixture for approximately 8 minutes to approximately 12 minutes at a humidity between approximately 15% and approximately 45% to achieve a core temperature in the meat pieces between approximately 165° F. and approximately 190° F.;
wherein the chilling of the cooked slugs of meat mixture comprises chilling the slugs of meat mixture from a core temperature between approximately 165° F. and approximately 190° F. down to a temperature between approximately 18° F. and approximately 36° F. within approximately 20 minutes;
wherein the packaging of the cooked slugs comprises reducing the amount of oxygen in the package to less than approximately 2%; and
wherein a refrigerated shelf life of the resulting cooked slugs is between approximately 14 weeks and approximately 22 weeks.

13. A pet treats processing system, comprising:
a grinding device configured to grind a meat base to obtain a ground meat base;
a mixing device configured to mix the ground meat base with one or more ingredients to obtain a meat mixture;
a forming device configured to form slugs of the meat mixture;
a cooking device configured to cook the slugs of meat mixture to obtain cooked slugs of meat mixture;
a cooling device configured to cool the cooked slugs of meat mixture; and
a packaging device configured to package the cooked slugs of meat mixture while reducing the amount of oxygen in the package.

14. The processing system of claim 13, further comprising:
a coating device configured to coat the slugs of meat mixture with a liquid; and
a browning device configured to brown the coated slugs of meat mixture.

15. The processing system of claim 14, wherein the browning device includes an open flame oven.

16. The processing system of claim 13, wherein the cooking device comprises a gas fired oven configured to operate with steam.

17. The processing system of claim 13, wherein the packaging device is configured to fill plastic bags with the slugs of meat mixture in an atmosphere filled with a gas comprising nitrogen, inert gas, carbon dioxide, or carbon monoxide, or any combination of two or more thereof.

18. The processing system of claim 13, further comprising a tempering device configured to decrease a temperature of the meat base to form chilled blocks of meat base, the grinding device grinding the chilled blocks of meat base.

19. A pet food treat, comprising:
slugs of a meat mixture formed from a mixture of meat base and one or more ingredients, wherein the slugs of meat mixture are formed by grinding a meat base, mixing the ground meat base with the one or more ingredients, forming slugs of the meat mixture, cooking the slugs of meat mixture, chilling the cooked slugs of meat mixture and packaging the cooked slugs of meat mixture while reducing the amount of oxygen in the package.

20. The pet food treat of claim 19, wherein the one or more ingredients includes a binding agent, a moisturizing compound, a salt, a sugar, an acid or a corresponding salt thereof, a mold inhibitor, an encapsulated acid, a flavoring and aroma compound, a coloring compound, or a condiment, or any combination of two or more thereof.

21. The pet food treat of claim 20, wherein the one or more ingredients includes the binding agent including oat four, soy flour, wheat flour, rice flour, potato flour, corn flour, rye flour, buckwheat flour, chestnut flour, chickpea flour, atta flour, pea flour, bean flour, amaranth flour, arrowroot flour, taro flour, cattail flour, acorn flour, sorghum flour, or tapioca flour, or any combination of two or more thereof.

22. The pet food treat of claim 20, wherein the one or more ingredients includes the moisturizing compound including water, broth from mammal, poultry or fish, juice including mammal, poultry or fish, or a combination of two or more thereof.

23. The pet food treat of claim 20, wherein the one or more ingredients includes the sugar including dextrose, maltodextrin, honey, high-fructose corn syrup, maltose, brown sugar, coconut sugar, date sugar, fructose, sucanat, molasses, turbinado sugar, corn syrup, dextrin, glucose, sucrose, sucralose, or any derivative thereof, or any combination of two or more thereof.

24. The pet food treat of claim 20, wherein the one or more ingredients includes the acid including citric acid, ascorbic acid, phosphoric acid, lactic acid, folic acid, acetic acid, adipic acid, benzoic acid, fumaric acid, maleic acid, propionic acid, sorbic acid, succinic acid, tartaric acid, or phytic acid, or any derivative thereof, or any combination of two or more thereof, or any corresponding salt thereof.

25. The pet food treat of claim 20, wherein the one or more ingredients includes the mold inhibitor including potassium sorbate, cultured whey, or calcium propionate, or any combination of two or more thereof.

26. The pet food treat of claim 20, wherein the one or more ingredients includes the encapsulated acid including encapsulated lactic acid, encapsulated citric acid, or encapsulated glucono-delta-lactone (GDL), or any derivative thereof, or any combination of two or more thereof.

27. The pet food treat of claim 20, wherein the one or more ingredients includes the flavoring and aroma compound including garlic, onion, natural smoke flavor, hickory, mesquite, anchovy, chicken, lobster, tikka, tandoori, or saffron, or any derivative thereof, or any combination of two or more thereof.

28. The pet food treat of claim 20, wherein the one or more ingredients includes the coloring compound including caramel coloring, malliouse, allura red AC, annatto, astaxanthin, betanin or beetroot red, blue 2, brilliant black BN, brilliant blue FCF, brown FK, canthaxanthin, carmine, carotene, crocin, curcumin, erythrosine, FD&C orange number 1, iron oxide, orange B, ponceau 6R, red 40, red 2G, saffron, sunset yellow FCF, tartrazine, titanium dioxide, turmeric, yellow 5, or yellow 2, or any combination of two or more thereof.

29. The pet food treat of claim 20, wherein the one or more ingredients includes the condiment including parsley flakes, carrots, spinach, tomatoes, potatoes, peas, rice, or pasta, or any combination of two or more thereof.
